(19) United States
(12) Patent Application Publication
(10) Pub. No.: US 2022/0391528 A1
(43) Pub. Date: Dec. 8, 2022

(54) ONLINE DOCUMENT DISPLAY METHOD AND APPARATUS, DEVICE AND MEDIUM

(71) Applicant: BEIJING BYTEDANCE NETWORK TECHNOLOGY CO., LTD., Beijing (CN)

(72) Inventors: Ronghui ZHANG, Beijing (CN); Xuelun REN, Beijing (CN)

(21) Appl. No.: 17/887,656

(22) Filed: Aug. 15, 2022

Related U.S. Application Data
(63) Continuation of application No. PCT/CN2021/074962, filed on Feb. 3, 2021.

(30) Foreign Application Priority Data
Feb. 20, 2020 (CN) 202010106780.3

(51) Int. Cl. G06F 21/62

(52) U.S. Cl. CPC G06F 21/6218

(57) ABSTRACT

An online document display method includes, in response to receiving a request of a current sharee to access an online document, acquiring the first permission setting information of the online document; determining, according to the first permission setting information, whether the current sharee has permission to access the online document; in response to a determination result that the current sharee has permission to access the online document, acquiring the second permission setting information of the content of each region among at least one region of the online document; and displaying the content of each region to the current sharee according to the second permission setting information of the content of each region. The second permission setting information of the content of each region includes the permission setting information of the content of each region within a set time period.

### CROSS-REFERENCES TO RELATED APPLICATIONS

This application is a continuation of International Patent Application No. PCT/CN2021/074962, filed on Feb. 3, 2021, which claims priority to Chinese Patent Application No. 202010106780.3 filed with the China National Intellectual Property Administration (CNIPA) on Feb. 20, 2020, the disclosure of which is incorporated herein by reference in its entirety.

### TECHNICAL FIELD

Embodiments of the present disclosure relate to the field of computer technology, for example, an online document display method and apparatus, an electronic device, and a storage medium.

### BACKGROUND

Mature online document products include Google documents, Microsoft documents, and Dropbox.

All of these online document products can be coedited online by multiple users, greatly facilitating smooth team communication at work. With regard to an online coedit, whether a participant has permission to access and edit the content of an online document may be determined according to a permission setting for the participant. However, this permission covers a too large control range to satisfy refined requirements of users in a collaborative office scenario.

### SUMMARY

Embodiments of the present disclosure provide an online document display method and apparatus, an electronic device, and a storage medium, limiting the operation permission for a set user to operate on the content of a region of an online document within a set time period.

An embodiment of the present disclosure provides an online document display method. The method includes, in response to receiving a request of a current sharee to access an online document, acquiring the first permission setting information of the online document; determining, according to the first permission setting information, whether the current sharee has permission to access the online document; in response to a determination result that the current sharee has permission to access the online document, acquiring the second permission setting information of the content of each region among at least one region of the online document; and displaying the content of each region to the current sharee according to the second permission setting information of the content of each region. The second permission setting information of the content of each region includes the permission setting information of the content of each region within a set time period.

An embodiment of the present disclosure provides an online document display apparatus. The apparatus includes a first permission setting information acquisition module configured to, in response to receiving a request of a current sharee to access an online document, acquire the first permission setting information of the online document; a determination module configured to determine, according to the first permission setting information, whether the current sharee has permission to access the online document; a second permission setting information acquisition module configured to, in response to a determination result that the current sharee has permission to access the online document, acquire the second permission setting information of the content of each region among at least one region of the online document; and a display module configured to display the content of each region to the current sharee according to the second permission setting information of the content of each region. The second permission setting information of the content of each region includes the permission setting information of the content of each region within a set time period.

An embodiment of the present disclosure provides a device. The device includes at least one processor and a storage apparatus configured to store at least one program. When executed by the at least one processor, the at least one program causes the at least one processor to perform the online document display method according to any embodiment of the present disclosure.

An embodiment of the present disclosure provides a storage medium including computer-executable instructions which, when executed by a computer processor, causes the computer processor to perform the online document display method according to any embodiment of the present disclosure.

### BRIEF DESCRIPTION OF DRAWINGS

The same or similar reference numerals throughout the drawings denote the same or similar elements. It is to be understood that the drawings are illustrative and that originals and elements are not necessarily drawn to scale.

FIG. 1 is a flowchart of an online document display method according to embodiment one of the present disclosure.

FIG. 2 is a diagram of the display interface of an online document according to embodiment one of the present disclosure.

FIG. 3 is a diagram of the display interface of another online document according to embodiment one of the present disclosure.

FIG. 4 is a flowchart of an online document display method according to embodiment two of the present disclosure.

FIG. 5 is a permission setting interface of an online document according to embodiment two of the present disclosure.

FIG. 6 is a diagram of a pop-up window according to embodiment two of the present disclosure.

FIG. 7 is a diagram of a pop-up window including set operation permission for multiple set users to operate on the selected content according to embodiment two of the present disclosure.

FIG. 8 is a diagram of a setting interface for the sharer to set, through an online document, the operation permission for a set user to operate on all of the content of the online document within a set time period according to embodiment two of the present disclosure.

FIG. 9 is a diagram of another pop-up window according to embodiment two of the present disclosure.

FIG. 10 is a diagram illustrating the structure of an online document display apparatus according to embodiment three of the present disclosure.

FIG. 11 is a diagram illustrating the structure of an electronic device according to embodiment four of the present disclosure.

### DETAILED DESCRIPTION

Embodiments of the present disclosure are described hereinafter with reference to the drawings. The drawings illustrate some embodiments of the present disclosure, but it is to be understood that the present disclosure may be implemented in various manners not limited to the embodiments set forth herein. It is to be understood that the drawings and embodiments of the present disclosure are illustrative and not intended to limit the scope of the present disclosure.

It is to be understood that steps described in method embodiments of the present disclosure may be performed in a different order and/or in parallel. Additionally, the method embodiments may include additional steps and/or omit execution of illustrated steps. The scope of the present disclosure is not limited in this respect.

The term “includes” used herein means “includes, but is not limited to”. The term “based on” used herein means “at least partially based on”. The term “an embodiment” used herein means “at least one embodiment”. The term “another embodiment” used herein means “at least another embodiment”. The term “some embodiments” used herein means “at least some embodiments”. Related definitions of other terms are given hereinafter.

Concepts such as “first” and “second” in the present disclosure are intended to distinguish between apparatuses, modules, or units and are not intended to limit the order of or interdependence between functions performed by these apparatuses, modules, or units.

“One” or “multiple” in the present disclosure is illustrative and not limiting. It is to be understood by those skilled in the art that “one” or “multiple” in the present disclosure is construed as “one or more” unless otherwise specified in the context.

### Embodiment One

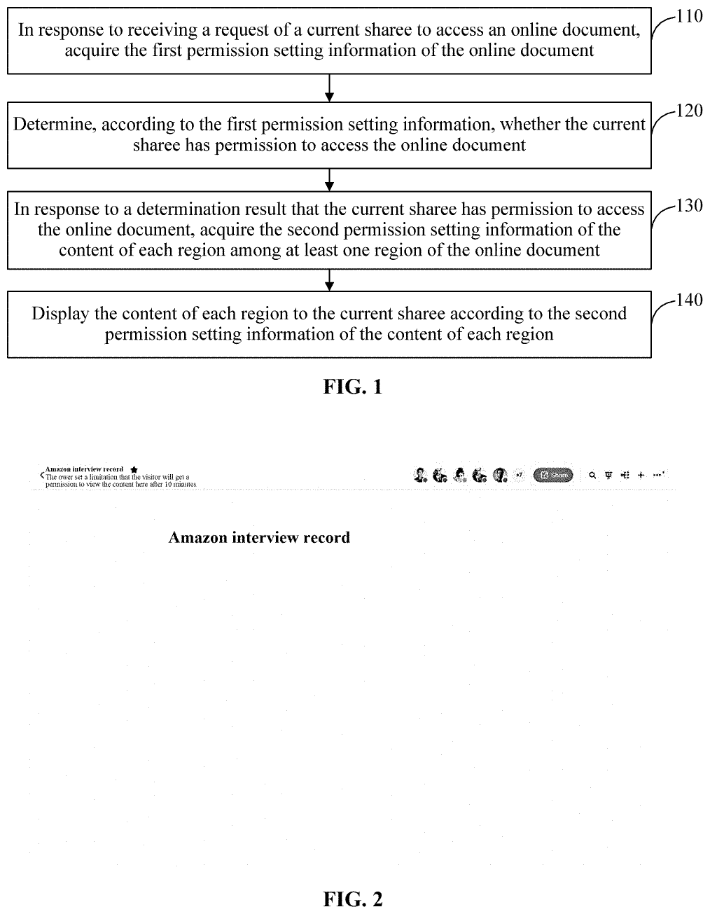

FIG. 1 is a flowchart of an online document display method according to embodiment one of the present disclosure. The method may be performed by an online document display apparatus. The apparatus may be implemented as at least one of software or hardware.

As shown in FIG. 1, the online document display method according to this embodiment of the present disclosure includes the steps below.

In step 110, in response to receiving a request of a current sharee to access an online document, the first permission setting information of the online document is acquired.

The first permission setting information includes prohibiting a preset sharee from viewing the online document or allowing a preset sharee to view the online document; or setting a preset sharee as the owner of the online document. The first permission setting information is usually set by the sharer of the online document. The sharer of the online document is usually the owner or creator of the online document. The sharer of the online document may set a sharee as the owner of the online document. The sharee set as the owner of the online document has the owner permission. That is, the sharer may set the operation permission for the sharee to operate on the online document. The operation permission includes viewing, editing, or owner permission.

In step 120, it is determined, according to the first permission setting information, whether the current sharee has permission to access the online document.

It is determined whether the sharee set with the first permission setting information includes the current sharee. If the sharee set with the first permission setting information includes the current sharee, it is determined, according to the permission content of the first permission setting information, whether the current sharee has permission to access the online document. For example, assuming that the current sharee is Zhang San, it is determined that Zhang San has permission to access the online document when the first permission setting information is allowing Zhang San to view the online document; and it is determined that Zhang San has no permission to access the online document when the first permission setting information is prohibiting Zhang San from viewing the online document.

In step 130, in response to a determination result that the current sharee has permission to access the online document, the second permission setting information of the content of each region among at least one region of the online document is acquired.

The second permission setting information of the content of each region includes the permission setting information of the content of each region within a set time period. The permission setting information of the content of each region within the set time period includes at least one of the following: prohibiting or allowing viewing of a preset sharee, prohibiting or allowing editing of a preset sharee, or setting a preset sharee as the owner of the online document.

In step 140, the content of each region is displayed to the current sharee according to the second permission setting information of the content of each region.

In an example, in the case where the permission setting information includes prohibiting viewing of the preset sharee, displaying the content of each region to the current sharee according to the second permission setting information of the content of each region includes determining whether the current sharee is included in the preset sharee in the permission setting information of the content of each region, and in response to a determination result that the current sharee is included in the preset sharee in the permission setting information of the content of each region, hiddenly displaying the content of each region within the set time period to prohibit the current sharee from viewing the content of each region within the set time period.

In the case where the content of each region is all of the body content of the online document, hiddenly displaying the content of each region includes displaying each region as a blank page, where the body content includes content other than the title content of the online document.

FIG. 2 is a diagram of the display interface of an online document. Referring to FIG. 2, only the title content “Amazon interview record” of the online document is displayed so that the current sharee is prohibited from viewing the content of the current region of the online document.

In the case where the content of each region is part of the body content of the online document, hiddenly displaying the content of each region includes displaying, according to the content type of the content of each region, the content of each region as set content corresponding to the content type.

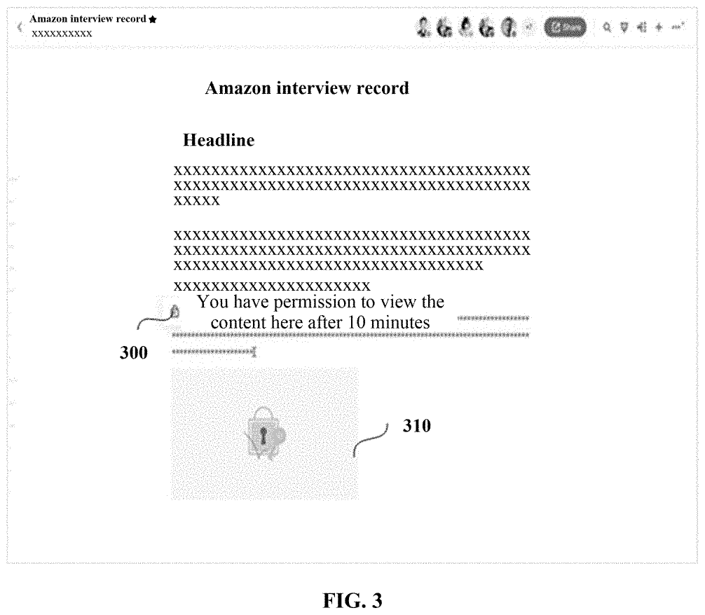

For example, if the content type of the content of the current region is text, the content of the current region is displayed as a set symbol, for example, “*”; and if the content type of the content of the current region is a picture, the content of the current region is displayed as a locked blank picture. FIG. 3 is a diagram of the display interface of another online document. Referring to FIG. 3, the content of a text-type region is displayed as a set symbol “*”, and the content of a picture-type region is displayed as a blank picture 310 having a key. In this manner, the content of the current region is hiddenly displayed, and thereby the permission of the current sharee is limited.

Displaying the content of each region to the current sharee according to the second permission setting information of the content of each region also includes displaying permission reminder information in an associated region of the content of each region to remind that the current sharee has permission to view the content of each region after the set time period.

The set time period is, for example, 10 minutes after the time when the permission setting information takes effect. As shown in FIG. 3, permission reminder information 300 is displayed in a suspended manner in an associated region of the content of the current region of the online document. The permission reminder information 300 is “you have permission to view the content here after 10 minutes”.

Displaying the content of each region to the current sharee according to the second permission setting information of the content of each region also includes in the case where the set time period after the time when the permission setting information of the content of each region takes effect expires, stopping hiddenly displaying the content of each region.

In an example in which the set time period is 10 minutes, when 10 minutes after the time when the permission setting information takes effect expires, the content of the current region is stopped from being hiddenly displayed, that is, the content of the current region is displayed in the current region of the online document. The content of a region of the online document is displayed to the current sharee according to the second permission setting information of the content of this region so that the operation permission for current sharee to operate on the content of this region in a set time period is limited.

In this solution in which the second permission setting information of the content of a certain region of the online document within the set time period is prohibiting viewing of the preset sharee by way of example, an implementation of the following is described: The content of this region of the online document is displayed to the current sharee according to the second permission setting information. When the second permission setting information of the content of a region of the online document is other information, for example, prohibiting editing of the preset sharee, the implementation is similar. That is, if the preset sharee includes the current sharee, the current sharee cannot edit the content of the certain region of the online document.

The online document display method according to this embodiment of the present disclosure includes, in response to receiving a request of a current sharee to access an online document, acquiring the first permission setting information of the online document; determining, according to the first permission setting information, whether the current sharee has permission to access the online document; in response to a determination result that the current sharee has permission to access the online document, acquiring the second permission setting information of the content of each region among at least one region of the online document; and displaying the content of each region to the current sharee according to the second permission setting information of the content of each region. The second permission setting information of the content of each region includes the permission setting information of the content of each region within a set time period. The method limits the operation permission for a set user to operate on the content of a region of the online document within the set time period.

### Embodiment Two

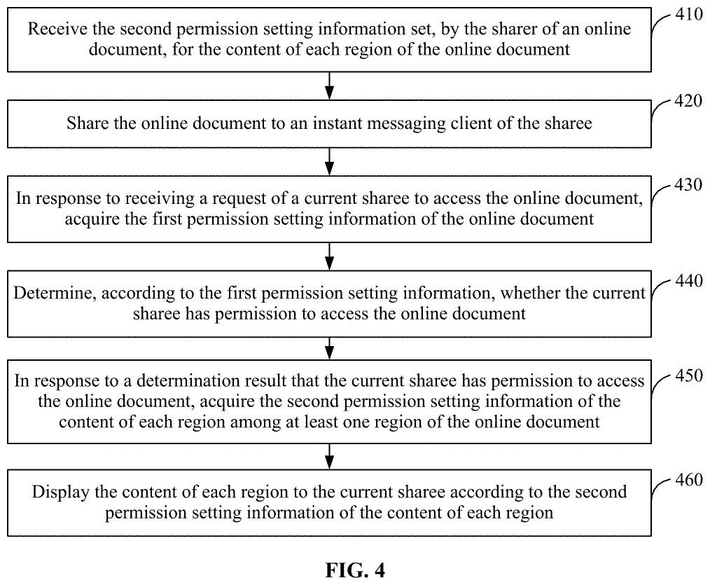

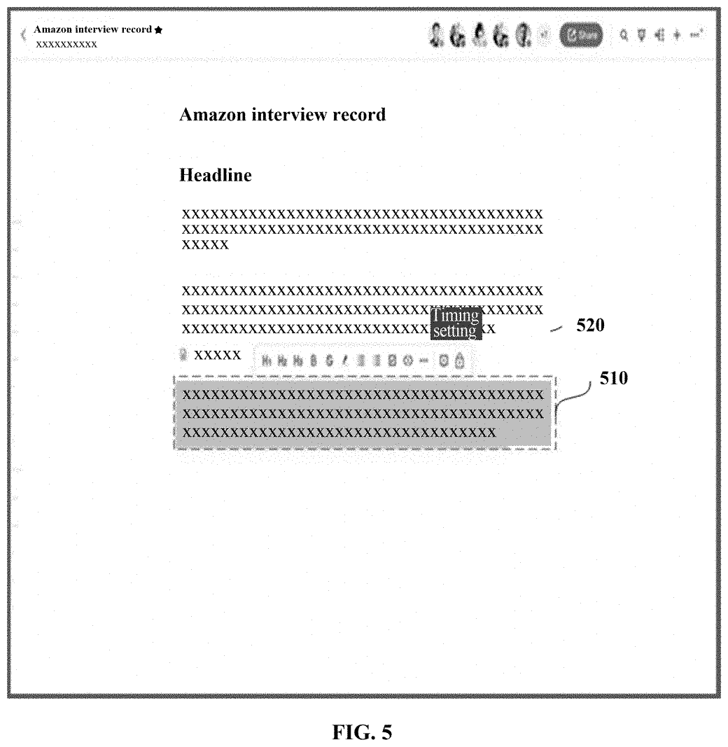

FIG. 4 is a flowchart of an online document display method according to embodiment two of the present disclosure. Based on the previous embodiment, this embodiment describes an implementation of setting second permission setting information for the content of a region of an online document. The method is applicable to a scenario where an object is fed back or evaluated anonymously based on an online document so that participants cannot view each other's information content fed back and so that the owner of the online document can view the information content fed back the participants but cannot view editing authors of the information content. The owner of the online document refers to the user who creates the current online document. Alternatively, the owner of the online document may be construed as the sharer of the online document, and other participating users are the sharers of the online document.

As shown in FIG. 4, the method includes the steps below.

In step 410, the second permission setting information set, by the sharer of an online document, for the content of each region of the online document is received.

The sharer of the online document sets second permission setting information for different contents of regions of the online document in different manners.

In an example, in the case where the content of each region is part of the body content of the online document, receiving the second permission setting information set, by the sharer of the online document, for the content of each region of the online document includes receiving a selection instruction of the content of each region, where the selection instruction is triggered by the sharer of the online document; displaying, according to the selection instruction, a permission setting button in a region associated with selected content; displaying, according to a trigger instruction for the permission setting button, a pop-up window for setting operation permission for the sharee to operate on the selected content, where the pop-up window includes the set time period and the operation permission; and receiving, through the pop-up window, the second permission setting information set for at least one sharee by the sharer of the online document.

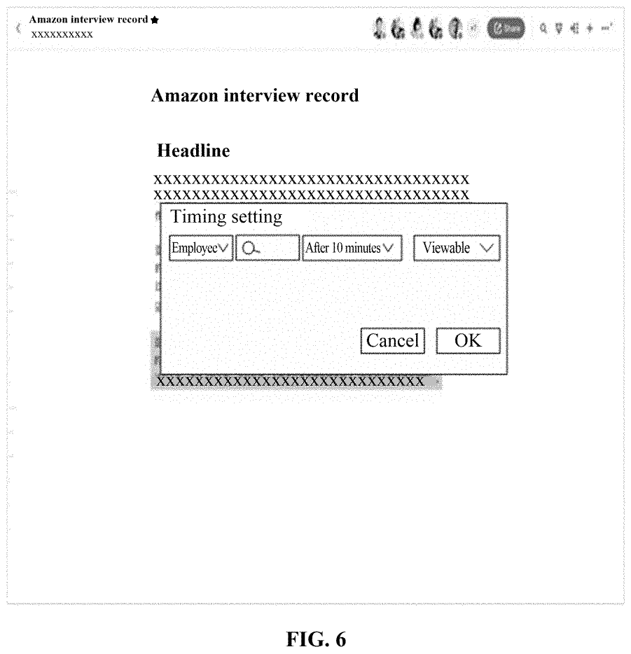

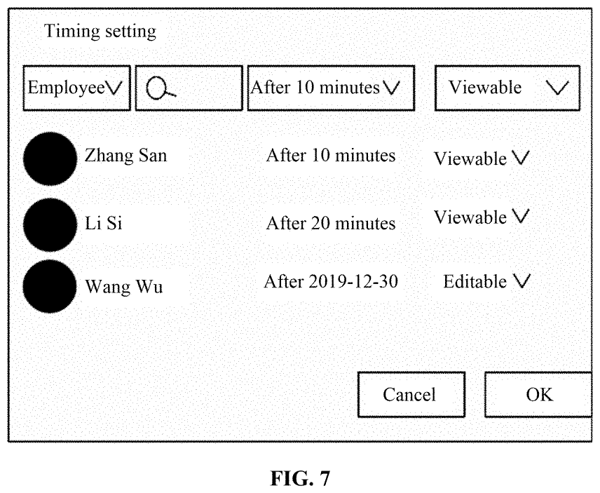

In an example, referring to FIG. 5, a permission setting interface of an online document, the sharer of the online document (hereinafter referred to as the sharer) selects partial content that the sharer wants to set permission for in the online document, for example, partial content 510 of FIG. 5. When the sharer selects the partial content 510, a permission setting button 520, for example, a “timing setting” button, is displayed in a suspended manner in an associated region of the selected content 510. The display region of the button is usually above the region where the selected content is located. Such a design is intended to make it easier for the sharer to capture the suspended button, thereby improving the user experience. The sharer clicks the “timing setting” button 520 to trigger a pop-up window as shown in FIG. 6. In the pop-up window as shown in FIG. 6, the sharer can set the operation permission for a set sharee to operate on the selected content. The default set time period and the default operation right are displayed in the pop-up window. As shown in FIG. 6, the default set time period displayed in the pop-up window is after 10 minutes, and the default operation right displayed in the pop-up window is “viewable”. The sharer may select the user, that is, the sharee, that the sharer wants to set permission for from the drop-down menu of “employee” or search for the target user through a search window so that the sharer can quickly find the user that the sharer wants to set permission for. The sharer may select the time period, for example “after 10 minutes”, “after 20 minutes”, or “after half an hour”, that the sharer wants to set from the drop-down menu of “set time period”. The sharer may also select the permission that the sharer wants to set from the drop-down menu of “permission”. The permission includes “viewable”, “editable”, or “owner permission”. For example, in the pop-up window as shown in FIG. 6, when the sharer clicks OK after setting the employee to “Zhang San”, the time period to “after 10 minutes”, and the operation permission to “viewable”, the permission setting information takes effect, that is, Zhang San cannot view the selected content of the online document within 10 minutes after the clicking time, as shown in FIG. 7 which is a diagram of a pop-up window including set operation permission for multiple set users to operate on the selected content.

In an example, in the case where the content of each region is all of the body content of the online document, receiving the second permission setting information set, by the sharer of the online document, for the content of each region of the online document includes receiving a trigger instruction of the sharer of the online document; displaying, according to the trigger instruction, a pop-up window for setting operation permission for the sharee to operate on all of the body content of the online document, where the pop-up window includes the set time period and the operation permission; and receiving the second permission setting information of the content of each region through the pop-up window.

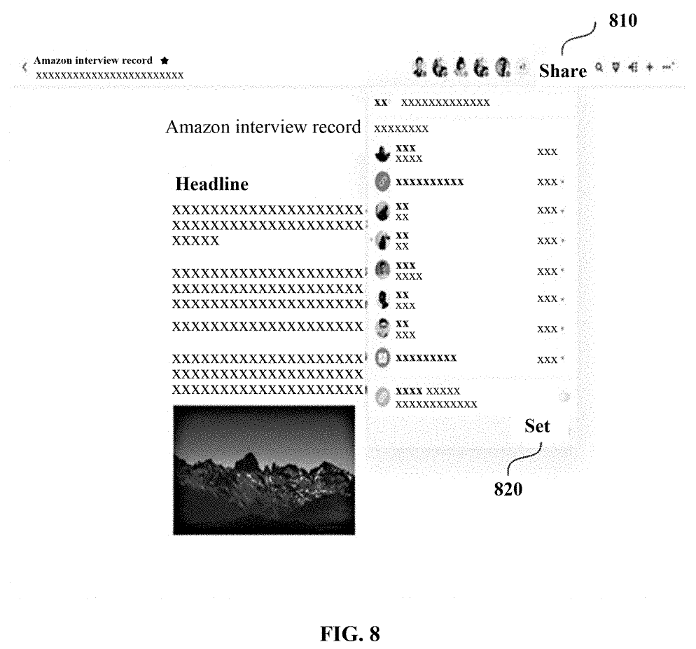

If the sharer wants to set user permission for all of the content of the online document, the sharer simply clicks a preset button set in the online document, saving the trouble of selecting all of the content of the online document. FIG. 8 is a diagram of a setting interface for the sharer to set, through an online document, the operation permission for a set user to operate on all of the content of the online document within a set time period. In FIG. 8, simply by clicking the preset button 810 (Share) set in the online document and selecting “Set” 820 in the lower right corner of the displayed cascading menu, the sharer can invoke a pop-up window for setting the operation permission for a set user to operate on all of the content of the online document, as shown in FIG. 9 which is a diagram of another pop-up window. The functions of the pop-up window shown in FIG. 9 are the same as the functions of the pop-up window shown in FIG. 6 and thus are not repeated here. For the functions of the pop-up window shown in FIG. 9, reference may be made to the description corresponding to FIG. 6.

In step 420, the online document is shared to an instant messaging client of the sharee.

The sharer shares the online document to an instant messaging client of the sharee to generate an online document notification message in a session list of the instant messaging client of the sharee to make the sharee initiate, through the online document notification message, the request to access the online document. In this manner, the sharee can be notified to check and participate in the online document in time.

In step 430, in response to receiving a request of a current sharee to access the online document, the first permission setting information of the online document is acquired.

In step 440, it is determined, according to the first permission setting information, whether the current sharee has permission to access the online document.

In step 450, in response to a determination result that the current sharee has permission to access the online document, the second permission setting information of the content of each region among at least one region of the online document is acquired.

In step 460, the content of each region is displayed to the current sharee according to the second permission setting information of the content of each region.

The second permission setting information of the content of each region includes the permission setting information of the content of each region within a set time period.

In the solution according to this embodiment of the present disclosure, the second permission setting information set, by the sharer of an online document, for the content of each region of the online document is received, where the second permission setting information includes the operation permission for a set member to operate on the content of the online document within a set time period, limiting the operation permission for the set user to operate on the content of the online document within the set time period.

In an example, the preceding solutions are applicable to a scenario where an object is fed back or evaluated anonymously. In this scenario, for the sake of the accuracy of the information and for the sake of the personal safety or interests of the users (that is, the sharees of the online document) participating in the feedback, the sharees cannot view each other's feedback before the deadline. However, the owner of the online document can view all the feedback content at any time but cannot view feedback authors of the feedback content. In this scenario, the owner of the online document, that is, the sharer of the online document, sets the permission of all of the users participating in the anonymous feedback, that is, the sharees of the online document, to having permission to view all of the content of the online document after 20 minutes. At this time, the sharees cannot view all of the content of the online document before the deadline, and all of the members participating in the anonymous feedback can write their real ideas without worry. It is to be noted that members participating in the anonymous feedback after the deadline can view the content fed back by other members but do not know feedback authors of the feedback content.

### Embodiment Three

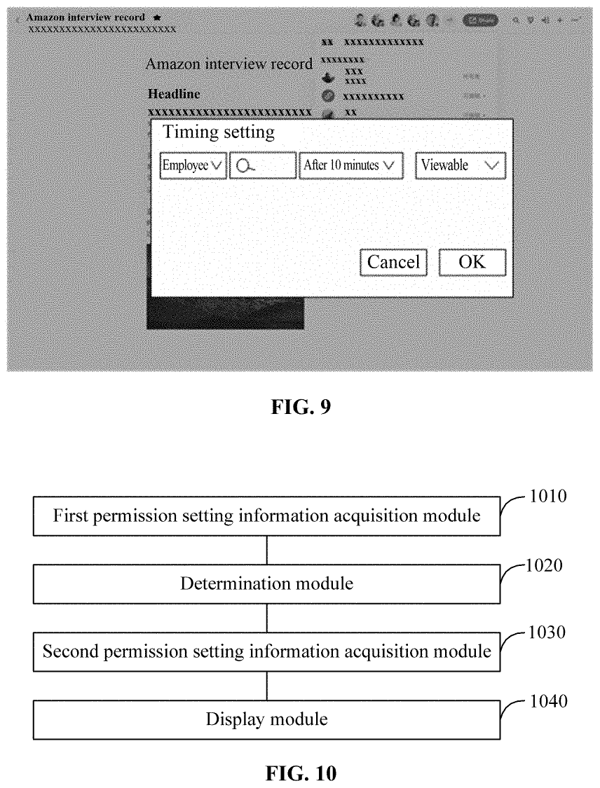

FIG. 10 is a diagram illustrating the structure of an online document display apparatus according to embodiment three of the present disclosure. The apparatus includes a first permission setting information acquisition module 1010, a determination module 1020, a second permission setting information acquisition module 1030, and a display module 1040. The first permission setting information acquisition module 1010 is configured to, in response to receiving a request of a current sharee to access an online document, acquire the first permission setting information of the online document. The determination module 1020 is configured to determine, according to the first permission setting information, whether the current sharee has permission to access the online document. The second permission setting information acquisition module 1030 is configured to, in response to a determination result that the current sharee has permission to access the online document, acquire the second permission setting information of the content of each region among at least one region of the online document. The display module 1040 is configured to display the content of each region to the current sharee according to the second permission setting information of the content of each region. The second permission setting information of the content of each region includes the permission setting information of the content of each region within a set time period.

Based on the preceding solution, the permission setting information of the content of each region within the set time period includes at least one of the following: prohibiting or allowing viewing of a preset sharee, prohibiting or allowing editing of a preset sharee, or setting a preset sharee as the owner of the online document.

Based on the preceding solution, in the case where the permission setting information includes prohibiting viewing of the preset sharee, the display module 1040 includes a first display unit configured to determine whether the current sharee is included in the preset sharee in the permission setting information of the content of each region, and in response to a determination result that the current sharee is included in the preset sharee in the permission setting information of the content of each region, hiddenly displaying the content of each region within the set time period to prohibit the current sharee from viewing the content of each region within the set time period.

Based on the preceding solution, the display module 1040 also includes a second display unit configured to display permission reminder information in an associated region of the content of each region to remind that the current sharee has permission to view the content of each region after the set time period.

Based on the preceding solution, in the case where the content of each region is all of the body content of the online document, the first display unit is configured to display each region as a blank page. The body content includes content other than the title content of the online document.

Based on the preceding solution, in the case where the content of each region is part of the body content of the online document, the first display unit is configured to display, according to the content type of the content of each region, the content of each region as the set content corresponding to the content type.

Based on the preceding solution, the second display unit is also configured to, in the case where the set time period after the time when the permission setting information of the content of each region takes effect expires, stop hiddenly displaying the content of each region.

Based on the preceding solution, the apparatus also includes a receiving module configured to receive the second permission setting information set, by the sharer of the online document, for the content of each region of the online document.

Based on the preceding solution, in the case where the content of each region is part of the body content of the online document, the receiving module includes a first receiving unit configured to receive a selection instruction of the content of each region, where the selection instruction is triggered by the sharer of the online document; a first display unit configured to display, according to the selection instruction, a permission setting button in a region associated with the selected content; a second display unit configured to display, according to a trigger instruction for the permission setting button, a pop-up window for setting operation permission for the sharee to operate on the selected content, where the pop-up window includes the set time period and the operation permission; and a second receiving unit configured to receive, through the pop-up window, the second permission setting information set for at least one sharee by the sharer of the online document.

Based on the preceding solution, in the case where the content of each region is all of the body content of the online document, the first receiving unit is also configured to receive a trigger instruction of the sharer of the online document; the second display unit is also configured to display, according to the trigger instruction, a pop-up window for setting operation permission for the sharee to operate on all of the body content of the online document, where the pop-up window includes the set time period and the operation permission; and the second receiving unit is also configured to receive the second permission setting information of the content of each region through the pop-up window.

Based on the preceding solution, the apparatus also includes a sharing module configured to, before, in response to receiving the request of the current sharee to access the online document, acquiring the first permission setting information of the online document, share the online document to an instant messaging client of the sharee to generate an online document notification message in a session list of the instant messaging client of the sharee to make the sharee initiate, through the online document notification message, the request to access the online document.

The solution according to this embodiment of the present disclosure includes, in response to receiving a request of a current sharee to access an online document, acquiring the first permission setting information of the online document; determining, according to the first permission setting information, whether the current sharee has permission to access the online document; in response to a determination result that the current sharee has permission to access the online document, acquiring the second permission setting information of the content of each region among at least one region of the online document; and displaying the content of each region to the current sharee according to the second permission setting information of the content of each region. The second permission setting information of the content of each region includes the permission setting information of the content of each region within a set time period. The solution limits the operation permission for a set user to operate on the content of a region of the online document within the set time period.

The online document display apparatus according to this embodiment of the present disclosure can perform the online document display method according to any embodiment of the present disclosure and has function modules corresponding to the performed method.

Units and modules of the apparatus are divided according to function logic. These units and modules may also be divided in other manners as long as the corresponding functions can be achieved. Moreover, names of these function units are used for distinguishing between these function units and not intended to limit the scope of this embodiment of the present disclosure.

### Embodiment Four

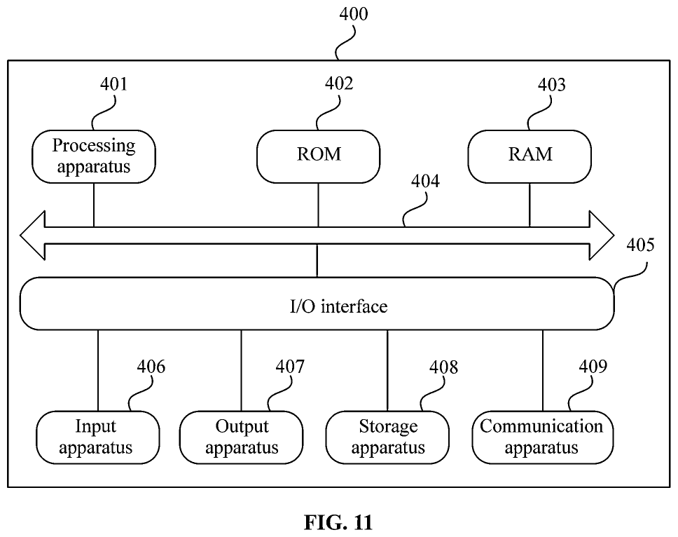

Referring to FIG. 11 which is a diagram illustrating the structure of an electronic device 400 (for example, the terminal device or server in FIG. 11) for performing an embodiment of the present disclosure, the terminal device in embodiments of the present disclosure may include, but is not limited to, mobile terminals such as a mobile phone, a laptop, a digital broadcast receiver, a personal digital assistant (PDA), a portable Android device (PAD), a portable media player (PMP) and an in-vehicle terminal (such as an in-vehicle navigation terminal), and stationary terminals such as a digital television (TV) and a desktop computer. The electronic device shown in FIG. 11 is merely an example and is not intended to limit the function and usage scope of the embodiments of the present disclosure.

As shown in FIG. 11, the electronic device 400 may include a processing apparatus 401 (such as a central processing unit or a graphics processor). The processing apparatus 401 may perform various appropriate actions and processing according to a program stored in a read-only memory (ROM) 402 or a program loaded into a random access memory (RAM) 403 from a storage apparatus 408. The RAM 403 also stores various programs and data required for the operation of the electronic device 400. The processing apparatus 401, the ROM 402 and the RAM 403 are connected to each other through a bus 404. An input/output (I/O) interface 405 is also connected to the bus 404.

The apparatus below may be connected to the I/O interface 405, including an input apparatus 406 such as a touch screen, a touch pad, a keyboard, a mouse, a camera, a microphone, an accelerometer and a gyroscope, an output apparatus 407 such as a liquid crystal display (LCD), a speaker and a vibrator, a storage apparatus 408 such as a magnetic tape and a hard disk, and a communication apparatus 409. The communication apparatus 409 may allow the electronic device 400 to perform wireless or wired communication with other devices so as to exchange data. FIG. 11 shows the electronic device 400 having various apparatuses, but it is not necessary to implement or be equipped with all the shown apparatuses. More or fewer apparatuses may be implemented instead.

According to embodiments of the present disclosure, the process described above with reference to the flowchart may be implemented as a computer software program. For example, the embodiments of the present disclosure include a computer program product. The computer program product includes a computer program carried in a non-transitory computer-readable medium. The computer program includes program codes for executing the methods shown in the flowcharts. In such an embodiment, the computer program may be downloaded from a network and installed through the communication apparatus 409, or may be installed from the storage apparatus 408, or may be installed from the ROM 402. When the computer program is executed by the processing apparatus 401, the preceding functions defined in the methods of the embodiments of the present disclosure are executed.

The terminal according to the embodiment of the present disclosure and the online document display method according to the preceding embodiments belong to the same concept, and for technical details not described in the embodiment of the present disclosure, reference may be made to the preceding embodiments.

### Embodiment Five

An embodiment of the present disclosure provides a computer storage medium storing a computer program which, when executed by a processor, implements the online document display method according to the preceding embodiments.

The computer-readable medium described above in the present disclosure may be a computer-readable signal medium or a computer-readable storage medium or any combination thereof. The computer-readable storage medium may be, but is not limited to, for example, an electronic, magnetic, optical, electromagnetic, infrared or semiconductor system, apparatus or device or any combination thereof. An example of the computer-readable storage medium may include, but is not limited to, an electrical connection having one or more wires, a portable computer magnetic disk, a hard disk, a RAM, a ROM, an erasable programmable read-only memory (EPROM), a flash memory, an optical fiber, a portable compact disc read-only memory (CD-ROM), an optical storage device, a magnetic storage device, or any suitable combination thereof. In the present disclosure, the computer-readable storage medium may be any tangible medium including or storing a program. The program may be used by or used in conjunction with an instruction execution system, apparatus, or device. In the present disclosure, the computer-readable signal medium may include a data signal propagated on a baseband or as a part of a carrier, and computer-readable program codes are carried in the data signal. The data signal propagated in this manner may be in multiple forms and includes, but is not limited to, an electromagnetic signal, an optical signal, or any suitable combination thereof. The computer-readable signal medium may also be any computer-readable medium other than the computer-readable storage medium. The computer-readable signal medium may send, propagate, or transmit a program used by or used in conjunction with an instruction execution system, apparatus, or device. The program codes included in the computer-readable medium may be transmitted in any suitable medium, including, but not limited to, a wire, an optical cable, a radio frequency (RF), or any suitable combination thereof.

In some embodiments, clients and servers may communicate using any currently known or future developed network protocol, such as the Hypertext Transfer Protocol (HTTP), and may be interconnected with any form or medium of digital data communication (for example, a communication network). Examples of the communication network include a local area network (LAN), a wide area networks (WAN), an internet (for example, the Internet), a peer-to-peer network (for example, an Ad-Hoc network), and any network currently known or to be developed in the future.

The preceding computer-readable medium may be included in the preceding electronic device or may exist alone without being assembled into the electronic device.

The preceding computer-readable medium stores one or more programs which, when executed by the electronic device, cause the electronic device to perform the following: In response to receiving a request of a current sharee to access an online document, acquiring the first permission setting information of the online document; determining, according to the first permission setting information, whether the current sharee has permission to access the online document; in response to a determination result that the current sharee has permission to access the online document, acquiring the second permission setting information of the content of each region among at least one region of the online document; and displaying the content of each region to the current sharee according to the second permission setting information of the content of each region. The second permission setting information of the content of each region includes the permission setting information of the content of each region within a set time period.

Computer program codes for executing the operations in the present disclosure may be written in one or more programming languages or combination thereof. The preceding one or more programming languages include, but are not limited to, object-oriented programming languages such as Java, Smalltalk and C++, as well as conventional procedural programming languages such as C or similar programming languages. The program codes may be executed entirely on a user computer, partly on a user computer, as a stand-alone software package, partly on a user computer and partly on a remote computer, or entirely on a remote computer or a server. In the case involving the remote computer, the remote computer may be connected to the user computer through any type of network including a LAN or a WAN, or may be connected to an external computer (for example, via the Internet through an Internet service provider).

The flowcharts and block diagrams in the drawings show possible architectures, functions and operations of the system, method and computer program product according to multiple embodiments of the present disclosure. In this regard, each block in the flowcharts or block diagrams may represent a module, a program segment, or part of codes that contains one or more executable instructions for implementing specified logical functions. It is also to be noted that in some alternative implementations, the functions marked in the blocks may occur in an order different from those marked in the drawings. For example, two successive blocks may, in fact, be executed substantially in parallel or in a reverse order, which depends on the functions involved. It is also to be noted that each block in the block diagrams and/or flowcharts and a combination of blocks in the block diagrams and/or flowcharts may be implemented by a special-purpose hardware-based system which executes specified functions or operations, or a combination of special-purpose hardware and computer instructions.

The units involved in the embodiments of the present disclosure may be implemented by software or hardware. The name of a unit is not intended to limit the unit in a certain circumstance, for example, an editable content display unit may also be described as an editing unit.

The functions described above herein may be executed, at least partially, by one or more hardware logic components. For example, without limitation, exemplary types of hardware logic components that may be used include a field programmable gate array (FPGA), an application-specific integrated circuit (ASIC), application-specific standard product (ASSP), a system on a chip (SoC), and a complex programmable logic device (CPLD).

In the context of the present disclosure, a machine-readable medium may be a tangible medium that may include or store a program that is used by or used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. Examples of the machine-readable storage medium may include an electrical connection based on one or more wires, a portable computer disk, a hard disk, a RAM, a ROM, an EPROM, a flash memory, an optical fiber, a CD-ROM, an optical storage device, a magnetic storage device, or any suitable combination thereof.

According to one or more embodiments of the present disclosure, example one provides an online document display method. The method includes, in response to receiving a request of a current sharee to access an online document, acquiring the first permission setting information of the online document; determining, according to the first permission setting information, whether the current sharee has permission to access the online document; in response to a determination result that the current sharee has permission to access the online document, acquiring the second permission setting information of the content of each region among at least one region of the online document; and displaying the content of each region to the current sharee according to the second permission setting information of the content of each region. The second permission setting information of the content of each region includes the permission setting information of the content of each region within a set time period.

According to one or more embodiments of the present disclosure, example two provides an online document display method. In the method, optionally, the permission setting information of the content of each region within the set time period includes at least one of the following: prohibiting or allowing viewing of a preset sharee, prohibiting or allowing editing of a preset sharee, or setting a preset sharee as the owner of the online document.

According to one or more embodiments of the present disclosure, example three provides an online document display method. In the method, optionally, in the case where the permission setting information includes prohibiting viewing of the preset sharee, displaying the content of each region to the current sharee according to the second permission setting information of the content of each region includes determining whether the current sharee is included in the preset sharee in the permission setting information of the content of each region, and in response to a determination result that the current sharee is included in the preset sharee in the permission setting information of the content of each region, hiddenly displaying the content of each region within the set time period to prohibit the current sharee from viewing the content of each region within the set time period.

According to one or more embodiments of the present disclosure, example four provides an online document display method. In the method, optionally, displaying the content of each region to the current sharee according to the second permission setting information of the content of each region also includes displaying permission reminder information in an associated region of the content of each region to remind that the current sharee has permission to view the content of each region after the set time period.

According to one or more embodiments of the present disclosure, example five provides an online document display method. In the method, optionally, in the case where the content of each region is all of the body content of the online document, hiddenly displaying the content of each region includes displaying each region as a blank page, where the body content includes content other than the title content of the online document.

According to one or more embodiments of the present disclosure, example six provides an online document display method. In the method, optionally, in the case where the content of each region is part of the body content of the online document, hiddenly displaying the content of each region includes displaying, according to the content type of the content of each region, the content of each region as set content corresponding to the content type.

According to one or more embodiments of the present disclosure, example seven provides an online document display method. In the method, optionally, displaying the content of each region to the current sharee according to the second permission setting information of the content of each region also includes in the case where the set time period after the time when the permission setting information of the content of each region takes effect expires, stopping hiddenly displaying the content of each region.

According to one or more embodiments of the present disclosure, example eight provides an online document display method. Optionally, the method also includes receiving the second permission setting information set, by the sharer of the online document, for the content of each region of the online document.

According to one or more embodiments of the present disclosure, example nine provides an online document display method. In the method, optionally, in the case where the content of each region is part of the body content of the online document, receiving the second permission setting information set, by the sharer of the online document, for the content of each region of the online document includes receiving a selection instruction of the content of each region, where the selection instruction is triggered by the sharer of the online document; displaying, according to the selection instruction, a permission setting button in a region associated with selected content; displaying, according to a trigger instruction for the permission setting button, a pop-up window for setting operation permission for the sharee to operate on the selected content, where the pop-up window includes the set time period and the operation permission; and receiving, through the pop-up window, the second permission setting information set for at least one sharee by the sharer of the online document.

According to one or more embodiments of the present disclosure, example ten provides an online document display method. In the method, optionally, in the case where the content of each region is all of the body content of the online document, receiving the second permission setting information set, by the sharer of the online document, for the content of each region of the online document includes receiving a trigger instruction of the sharer of the online document; displaying, according to the trigger instruction, a pop-up window for setting operation permission for the sharee to operate on all of the body content of the online document, where the pop-up window includes the set time period and the operation permission; and receiving the second permission setting information of the content of each region through the pop-up window.

According to one or more embodiments of the present disclosure, example eleven provides an online document display method. In the method, optionally, before, in response to receiving the request of the current sharee to access the online document, acquiring the first permission setting information of the online document, the method also includes sharing the online document to an instant messaging client of the sharee to generate an online document notification message in a session list of the instant messaging client of the sharee to make the sharee initiate, through the online document notification message, the request to access the online document.

According to one or more embodiments of the present disclosure, example twelve provides an online document display apparatus. The apparatus includes a first permission setting information acquisition module configured to, in response to receiving a request of a current sharee to access an online document, acquire the first permission setting information of the online document; a determination module configured to determine, according to the first permission setting information, whether the current sharee has permission to access the online document; a second permission setting information acquisition module configured to, in response to a determination result that the current sharee has permission to access the online document, acquire the second permission setting information of the content of each region among at least one region of the online document; and a display module configured to display the content of each region to the current sharee according to the second permission setting information of the content of each region. The second permission setting information of the content of each region includes the permission setting information of the content of each region within a set time period.

According to one or more embodiments of the present disclosure, example thirteen provides an electronic device. The electronic device includes one or more processors and a storage apparatus configured to store one or more programs. When executed by the one or more programs, the one or more programs cause the one or more processors to perform the following online document display method: in response to receiving a request of a current sharee to access an online document, acquiring the first permission setting information of the online document; determining, according to the first permission setting information, whether the current sharee has permission to access the online document; in response to a determination result that the current sharee has permission to access the online document, acquiring the second permission setting information of the content of each region among at least one region of the online document; and displaying the content of each region to the current sharee according to the second permission setting information of the content of each region. The second permission setting information of the content of each region includes the permission setting information of the content of each region within a set time period.

According to one or more embodiments of the present disclosure, example fourteen provides a storage medium including computer-executable instructions which, when executed by a computer processor, causes the computer processor to perform the following online document display method: in response to receiving a request of a current sharee to access an online document, acquiring the first permission setting information of the online document; determining, according to the first permission setting information, whether the current sharee has permission to access the online document; in response to a determination result that the current sharee has permission to access the online document, acquiring the second permission setting information of the content of each region among at least one region of the online document; and displaying the content of each region to the current sharee according to the second permission setting information of the content of each region. The second permission setting information of the content of each region includes the permission setting information of the content of each region within a set time period.

In addition, although the operations are depicted in a particular order, this should not be construed as requiring that such operations should be performed in the particular order shown or in a sequential order. In certain circumstances, multitasking and parallel processing may be advantageous. Similarly, although implementation details are included in the preceding discussion, these should not be construed as limiting the scope of the present disclosure. Some features described in the context of separate embodiments may also be implemented in combination in a single embodiment. Various features described in the context of a single embodiment may also be implemented in a plurality of embodiments, individually or in any suitable sub-combination.

What is claimed is:

1. An online document display method, comprising:
in response to receiving a request of a current sharee to access an online document, acquiring first permission setting information of the online document;
determining, according to the first permission setting information, whether the current sharee has permission to access the online document;
in response to a determination result that the current sharee has the permission to access the online document, acquiring second permission setting information of content of each region among at least one region of the online document; and
displaying the content of the each region to the current sharee according to the second permission setting information of the content of the each region,
wherein the second permission setting information of the content of the each region comprises permission setting information of the content of the each region within a set time period.

2. The method of claim 1, wherein the permission setting information of the content of the each region within the set time period comprises at least one of the following: prohibiting or allowing viewing of a preset sharee, prohibiting or allowing editing of a preset sharee, or setting a preset sharee as an owner of the online document.

3. The method of claim 2, wherein in a case where the permission setting information comprises prohibiting viewing of the preset sharee, displaying the content of the each region to the current sharee according to the second permission setting information of the content of the each region comprises:
determining whether the current sharee is comprised in the preset sharee in the permission setting information of the content of the each region, and in response to a determination result that the current sharee is comprised in the preset sharee in the permission setting information of the content of the each region, hiddenly displaying the content of the each region within the set time period to prohibit the current sharee from viewing the content of the each region within the set time period.

4. The method of claim 3, wherein displaying the content of the each region to the current sharee according to the second permission setting information of the content of the each region further comprises:
displaying permission reminder information in an associated region of the content of the each region to remind that the current sharee has permission to view the content of the each region after the set time period.

5. The method of claim 3, wherein in a case where the content of the each region is all of body content of the online document, hiddenly displaying the content of the each region comprises:
displaying the each region as a blank page, wherein the body content comprises content other than title content of the online document.

6. The method of claim 3, wherein in a case where the content of the each region is part of body content of the online document, hiddenly displaying the content of the each region comprises:
displaying, according to a content type of the content of the each region, the content of the each region as set content corresponding to the content type.

7. The method of claim 3, wherein displaying the content of the each region to the current sharee according to the second permission setting information of the content of the each region further comprises:
in a case where the set time period after a time when the permission setting information of the content of the each region takes effect expires, stopping hiddenly displaying the content of the each region.

8. The method of claim 1, further comprising:
receiving the second permission setting information set, by a sharer of the online document, for the content of the each region of the online document.

9. The method of claim 2, further comprising:
receiving the second permission setting information set, by a sharer of the online document, for the content of the each region of the online document.

10. The method of claim 3, further comprising:
receiving the second permission setting information set, by a sharer of the online document, for the content of the each region of the online document.

11. The method of claim 4, further comprising:
receiving the second permission setting information set, by a sharer of the online document, for the content of the each region of the online document.

12. The method of claim 5, further comprising:
receiving the second permission setting information set, by a sharer of the online document, for the content of the each region of the online document.

13. The method of claim 6, further comprising:
receiving the second permission setting information set, by a sharer of the online document, for the content of the each region of the online document.

14. The method of claim 7, further comprising:
receiving the second permission setting information set, by a sharer of the online document, for the content of the each region of the online document.

15. The method of claim 8, wherein in a case where the content of the each region is part of body content of the online document, receiving the second permission setting information set, by the sharer of the online document, for the content of the each region of the online document comprises:
receiving a selection instruction of the content of the each region, wherein the selection instruction is triggered by the sharer of the online document;
displaying, according to the selection instruction, a permission setting button in a region associated with selected content;
displaying, according to a trigger instruction for the permission setting button, a pop-up window for setting operation permission for the sharee to operate on the selected content, wherein the pop-up window comprises the set time period and the operation permission; and
receiving, through the pop-up window, the second permission setting information set for at least one sharee by the sharer of the online document.

16. The method of claim 8, wherein in a case where the content of the each region is all of body content of the online document, receiving the second permission setting information set, by the sharer of the online document, for the content of the each region of the online document comprises:
receiving a trigger instruction of the sharer of the online document;
displaying, according to the trigger instruction, a pop-up window for setting operation permission for the sharee to operate on all of the body content of the online document, wherein the pop-up window comprises the set time period and the operation permission; and
receiving the second permission setting information of the content of the each region through the pop-up window.

17. The method of claim 10, before, in response to receiving the request of the current sharee to access the online document, acquiring the first permission setting information of the online document, the method further comprising:
sharing the online document to an instant messaging client of the sharee to generate an online document notification message in a session list of the instant messaging client of the sharee to make the sharee initiate, through the online document notification message, the request to access the online document.

18. An electronic device, comprising:
at least one processor; and
a storage apparatus configured to store at least one program,
wherein when executed by the at least one processor, the at least one program causes the at least one processor to perform the following steps:
in response to receiving a request of a current sharee to access an online document, acquiring first permission setting information of the online document;
determining, according to the first permission setting information, whether the current sharee has permission to access the online document;
in response to a determination result that the current sharee has the permission to access the online document, acquiring second permission setting information of content of each region among at least one region of the online document; and
displaying the content of the each region to the current sharee according to the second permission setting information of the content of the each region,
wherein the second permission setting information of the content of the each region comprises permission setting information of the content of the each region within a set time period.

19. The device of claim 18, wherein the permission setting information of the content of the each region within the set time period comprises at least one of the following: prohibiting or allowing viewing of a preset sharee, prohibiting or allowing editing of a preset sharee, or setting a preset sharee as an owner of the online document.

20. A non-transitory storage medium comprising computer-executable instructions which, when executed by a computer processor, causes the computer processor to perform the following steps:
in response to receiving a request of a current sharee to access an online document, acquiring first permission setting information of the online document;
determining, according to the first permission setting information, whether the current sharee has permission to access the online document;
in response to a determination result that the current sharee has the permission to access the online document, acquiring second permission setting information of content of each region among at least one region of the online document; and
displaying the content of the each region to the current sharee according to the second permission setting information of the content of the each region,
wherein the second permission setting information of the content of the each region comprises permission setting information of the content of the each region within a set time period.
